(19) United States
(12) Patent Application Publication
(10) Pub. No.: US 2009/0136293 A1
(43) Pub. Date: May 28, 2009

(54) TWO WIRE SIGNAL OVER POWER WORK TOOL COUPLING AND IDENTIFICATION

(75) Inventor: James Brian Normann, Holly Springs, NC (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: CATERPILLAR S.A.R.L., Geneva (CH)

(21) Appl. No.: 11/946,695

(22) Filed: Nov. 28, 2007

(51) Int. Cl. F16B 17/00

(52) U.S. Cl. 403/345; 340/533; 172/272

(57) ABSTRACT

A coupler for a machine is disclosed. The coupler includes a housing sized to matingly engage a corresponding coupler housing. An electrical connector, disposed within the coupler housing is configured to create an electrical connection between the tool and the machine at a communication node. The electrical connection provides a circuit pathway for a conductor delivering both power and data to a plurality of devices connected to the machine. A message containing tool identification information is transmitted from the communication node when the coupler housing is connected to the complimentary coupler housing.

### TECHNICAL FIELD

This patent disclosure relates generally to a system and method for making connections between a work tool and a machine and, more particularly to a system and method for communicating with tools attached to a machine using common conductors for data and power delivery.

### BACKGROUND

Industrial, construction, and earth-moving machines, e.g., hydraulic excavators, backhoes, loaders, graders and compactors, are becoming increasingly complex as their roles and capabilities expand. The additional complexity often allows the machines to perform assigned tasks more efficiently and precisely. Most such machines are powered, controlled and monitored via electronic equipment, such as computers, microcontrollers, and sensors. Typically, numerous electrical conductors routed throughout the machine provide power and data to its components. Example components located on some machines include engine controllers, user controls and work tool attachments. Work tool attachments may include, for example, buckets, hooks and forks, as well as other tools.

Traditionally, power and data are delivered between the machine and any attachments via separate conductors. An operator controls the devices from a central location with data routed through independent data conductors to each device. Similarly, the power for each device originates at a power source and is independently routed to each device on the machine through power conductors.

A single work tool may have multiple data conductors routed to the operator location, as well as one or more power conductors routed to the power source. Each time a new work tool is connected to the machine, each of the multiple data and power connections must be established. In order to establish the connections, an operator must exit the operator station, go to the work tool and physically connect each conductor between the machine and the work tool. Additionally, the operator must physically connect all hydraulic connections between the machine and the work tool. If the operator changes work tools frequently, connecting and unconnecting each electrical and hydraulic connection on the work tools becomes a time consuming, labor-intensive task.

Moreover, since two conductors are required for each device on the machine, the total number of conductors increases proportionally to the number of devices used by the machine. During assembly, conductors are bundled into complex and cumbersome wiring harnesses. As the number of conductors increases, the wiring harness becomes larger and harder to route throughout the machine. The cost and weight of the wiring harness also increases as additional devices are added to a machine. Additionally, because so many conductors are routed in close proximity to one another, the conductors could short together, preventing the machine from operating properly and potentially damaging devices on the machine. These problems will only become worse in the future, as such machines grow even more complex and are extended to contain additional devices.

Attempts have been made to use a data communication system wherein data and power are routed over the same conductors. For example, it is known in motor vehicles to arrange functional devices to communicate with each other through supply conductors connected to the battery of the vehicle by means of a carrier current technique. One example of a data communication system employing the use of carrier currents is disclosed by U.S. Pat. No. 5,745,027, to Malville. Malville, however, does not disclose features that would enable a combination of power and data delivery throughout a machine. For example, Malville does not disclose smart connectors that connect devices to a wire bus that are configured to communicate and work with other smart connectors. Malville also does not disclose techniques in which smart connectors are readily connected to the bus at any desired location during assembly, maintenance or upgrades. Furthermore, Malville does not disclose techniques for delivering large amounts of data over a combined power and data delivery bus that accounts for and compensates for data interference in harsh environments. Finally, Malville does not disclose quick connection of work tools to a machine utilizing a system with data and power routed over the same conductors.

### BRIEF SUMMARY

The disclosure describes, in one aspect, a coupler for a machine. The coupler includes a housing sized to matingly engage a corresponding coupler housing. An electrical connector, disposed within the coupler housing is configured to create an electrical connection between the tool and the machine at a communication node. The electrical connection provides a circuit pathway for a conductor delivering both power and data to a plurality of devices connected to the machine. A message containing tool identification information is transmitted from the communication node when the coupler housing is connected to the complimentary coupler housing.

The machine includes a conductor for delivering power and data throughout the machine. A plurality of nodes, including the work tool, may be attached to the conductor. A system controller may be attached to the conductor to assign unique identifiers to each node. Further, the system controller may facilitate the flow of data on the conductor.

### BRIEF DESCRIPTION OF THE DRAWINGS

FIG. 1 shows a coupler having electrical and hydraulic connections according to one embodiment of the present disclosure;

FIG. 2A is an elevation view of a work tool coupler providing electrical and hydraulic connections from a work tool to a machine according to one embodiment of the present disclosure;

FIG. 2B is a side view of the work tool coupler of FIG. 2A;

FIG. 3A is an elevation view of a complimentary coupler to the coupler illustrated in FIG. 2A, providing electrical and hydraulic connections from a work tool to a machine according to one embodiment of the present disclosure;

FIG. 3B is a side view of the complimentary coupler of FIG. 3A;

FIG. 4 shows diagrammatically a power and data delivery system according to one embodiment of the present disclosure;

FIG. 5 is a cross sectional view of a smart connector plugged into the conductor according to one embodiment of the present disclosure;

FIG. 6 is a block diagram of a smart chip connected to the conductor according to one embodiment of the present disclosure; and

FIG. 7 is a flow diagram depicting steps of operation of a quick connect system for a work tool that utilizes a power and data delivery system according to one embodiment of the present disclosure.

### DETAILED DESCRIPTION

This disclosure relates to a device for connecting and enumerating a work tool to a machine utilizing two electrical conductors. In one embodiment, a quick connect coupler allows the operator of a machine to attach a work tool to the machine without having to manually create electrical and hydraulic connections between the work tool and the machine.

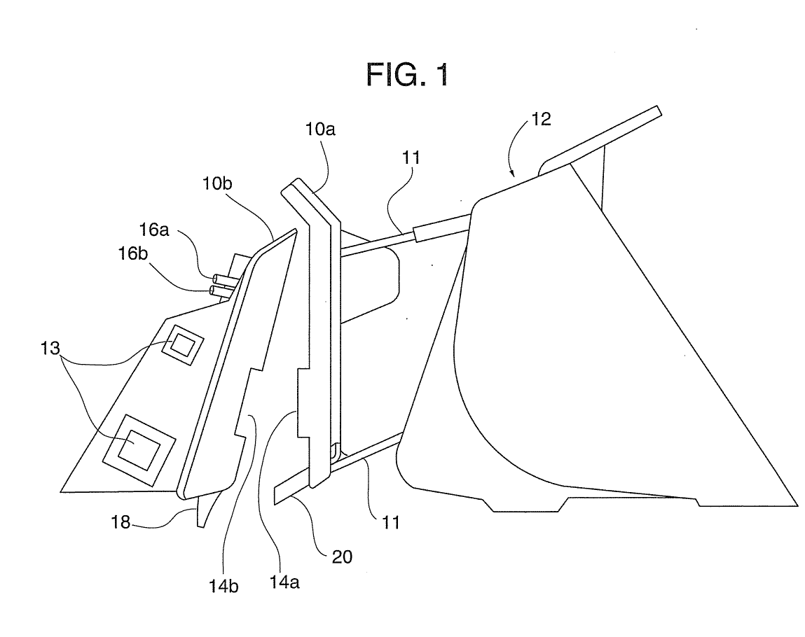

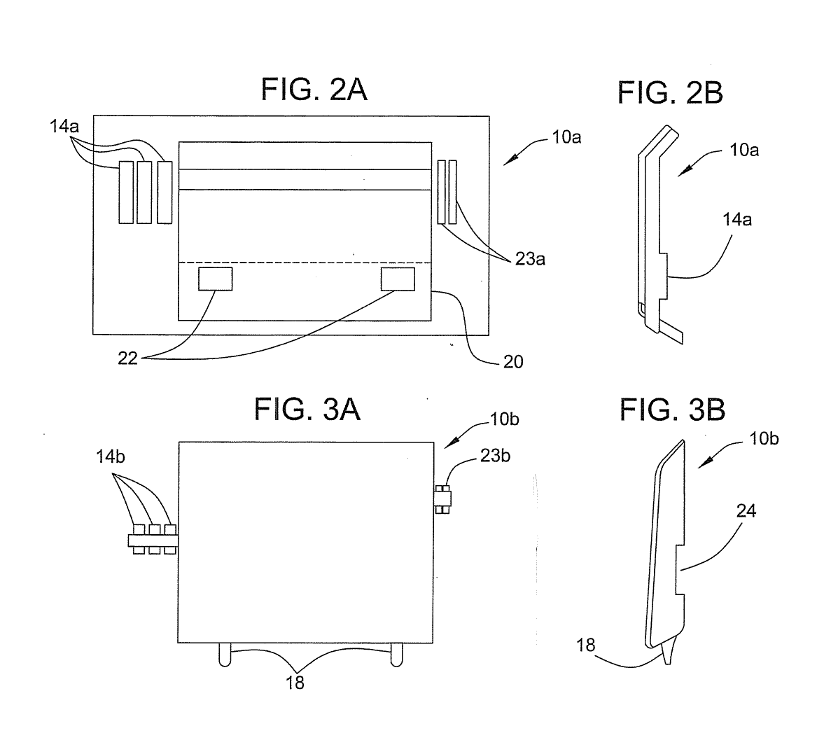

FIG. 1 is a schematic diagram of a work tool 12 including a work tool coupler 10a that electrically and hydraulically communicates with a machine via a complimentary coupler 10b. The work tool coupler 10a is attached to the work tool 12 by first and second work tool supports 11a and 11b. The complimentary coupler 10b is in turn secured to a machine using any appropriate means, such as sockets 13. The illustrated work tool 12 may be any type of tool that is capable of being attached to the machine. For example, in one embodiment, the work tool 12 is a skid steer loader. The work tool coupler 10a and complimentary coupler 10b include a mechanism for creating hydraulic connections between the work tool 12 and the machine without manual operator intervention. The hydraulic connection is further described below with reference to FIG. 2. The work tool coupler 10a includes a tool coupler housing sized to mate with the complimentary coupler 10b.

The complimentary coupler 10b includes first electrical conductor 16a and second electrical conductor 16b that connect to a power and data system for the machine (not shown) and are adapted to transmit and deliver power and data. The first electrical conductor 16a and second electrical conductor 16b provide the work tool 12 with all necessary power and data signals. The first electrical conductor 16a transmits a positive voltage while the second electrical conductor 16b provides a reference ground signal. Using a single pair of conductors reduces wiring complexity and the number of electrical connections that must be made between the work tool 12 and the machine. The work tool coupler 10a and complimentary coupler 10b are mechanically mated using pins 18 that engage receiving slots in plate 20. The mechanical connection is further explained in connection with FIG. 2 below.

FIG. 2A is an elevation view of the work tool coupler 10a. Plate 20 is illustrated with receiving slots 22. Pins 18 engage receiving slots 22 to mechanically connect the work tool 12 to the machine. Hydraulic connectors 14a on the work tool coupler 10a connect the work tool to the machine's hydraulic system. The hydraulic connectors 14a mate with complementary hydraulic connectors 14b on the complimentary coupler 10b. The hydraulic connector passes hydraulic fluid between the machine and the work tool. Complementary electrical connectors 23a connect the work tool to the machine's power and data delivery system thru electrical connectors 23b. The electrical connectors 23b and complementary electrical connectors 23a allow both power and data signals to pass from the machine to the work tool without the need for multiple pairs of conductors. FIG. 2B is a side elevation view of the work tool coupler 10a. Hydraulic connectors 14a are visible extending from the work tool coupler 10a.

Relevant structural details of the complimentary machine coupler are illustrated in FIG. 3A. Pins 18 engage receiving slots 22 on the work tool coupler 10a in order to create a mechanical connection between the tool and the machine. Complementary hydraulic connectors 14b include a pluggable portion such that the operator engages the complementary hydraulic connectors 14b with hydraulic connectors 14a from the operator station of the machine. Thus, the operator does not need to exit the vehicle to manually connect the hydraulic system between the tool and the machine. The complementary hydraulic connectors 14b may include a valve that closes when the machine is not connected to the work tool. The valve prevents the leaking of hydraulic fluid. The valve opens either automatically when the tool is connected to the machine so that hydraulic fluid flows to the work tool. The valves may alternatively be operated manually.

Electrical connectors 23b located on the complimentary coupler 10b engage complementary electrical connectors 23a located on the work tool coupler 10a. Any suitable mechanism for engaging electrical connectors 23b and complementary electrical connectors 23a without manual operator intervention may be used within the disclosed principles. One embodiment utilizes one or more solenoids to move at least one set of the connectors, such as electrical connectors 23b located on the complimentary coupler 10b, into engagement with the mating connectors, such as complementary electrical connectors 23a located on the work tool coupler 10a. In this embodiment, electrical connectors 23b are male, and complementary electrical connectors 23a are female. However, in an alternative embodiments, the electrical connectors 23b are female connectors while the complementary electrical connectors 23a are male connectors.

FIG. 3B illustrates a side elevation view of the complimentary coupler. In one embodiment, hydraulic connectors 14a engage complementary hydraulic connectors 14b in a receiving portion 24 of the complimentary coupler 10b.

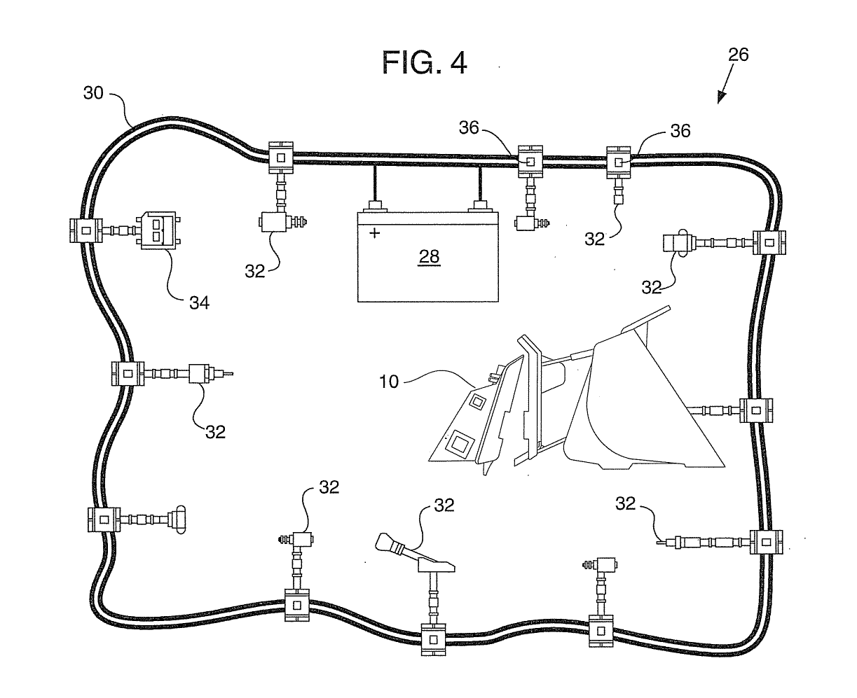

FIG. 4 is a diagrammatic view of a power and data delivery system 26 including the work tool coupler 10a. The power and data delivery system 26 is routed throughout the machine and to any work tools attached to the machine that need electrical power and/or data. The power and data delivery system 26 connects to the machine's electrical power source, such as a battery 28. The power and data delivery system 26 may include conductors such as a two-wire configuration, but may also include other configurations including, but not limited to, a one-wire configuration, for example with a common chassis ground. The power and data delivery system 26 may be arranged such that a conductor 30 is operably connected to all devices 32 requiring communication with the system controller 34 or with other devices 32, and requiring power from the power supply, such as the battery 28. The transfer of data and power preferably occurs over the same conductor 30. Devices 32 may include, but are not limited to, work tools, solenoids, sensors, relays, throttle shifters, lights, alarms, cameras and any other electrical device that may be present on the machine. Devices 32 are operably connected to the conductor 30 via smart connectors 36. A smart connector 36 may also be characterized as a node, a processing node, a tap, an electrical smart connector and the like. Each device 32 may have its own smart connector 36, as shown in FIG. 2. The machine may also include at least one system controller 34, the controller also being a type of device 32. Additionally, the work tool 12 is another type of device 32.

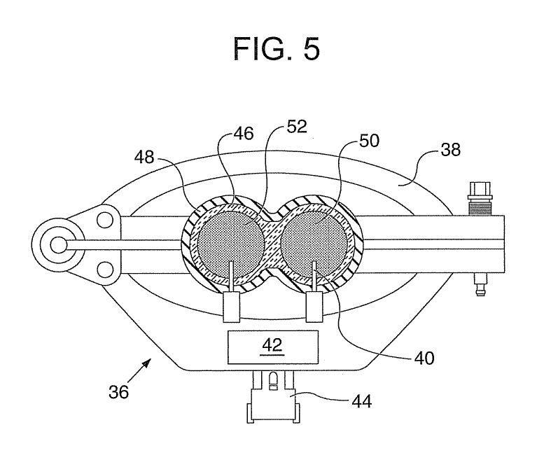

FIG. 5 is a cross sectional view of a smart connector 36 connected to the conductor 30 according to one embodiment of the present disclosure. The smart connector 36 may comprise a housing 38, prongs 40, a smart chip 42, and a device connector 44. The smart connector 36 may be connected to the conductor 30 at any location along the conductor 30 where it may be desired to connect a device 32, such as the work tool 12. The connection of a smart connector 36 may occur during assembly of the machine or at a later time, such as when a new device 32 is attached to the machine. For example, the smart connector 36 may be housed in the work tool coupler 10a and connect to the machine when the work tool coupler 10a mates with the complimentary coupler 10b.

Connection of the smart connector 36 to the power and conductor 30 may require that the smart connector 36 have at least one prong 40 that may penetrate the insulation 46 and sheathing 48 of the conductor 30 and independently contact a corresponding at least one of the positive and/or negative lines 50, 52. In one embodiment, there are 2 prongs 40, one prong 40 to contact the positive line 50 and one prong 40 to contact the negative line 52.

Ensuring a proper connection may include techniques such as clearly marking the conductor 30 and the prongs 40 with positive or negative markings, color codes or other types of markings so that the correct polarity between the contacts is made. In one embodiment of the disclosure, the prongs 40 may assume the shape of knife-like structures with a predetermined curvature for easier penetration into the conductor 30. The use of finely stranded lines in the conductor 30 allows the prongs 40 to readily penetrate into the positive and negative lines 50, 52 for enhanced electrical contact. The housing 38 may also allow for a predetermined offset of the prongs 40 from the conductor 30 such that assembly of the housing 38 about the conductor 30 will ensure a proper depth of penetration of the prongs 40 into the conductor 30.

The conductor 30 may be routed from the machine through the complimentary coupler 10b to the work tool coupler 10a. If the conductor 30 is routed to the work tool coupler 10a, the smart connector 36 can be located in the work tool coupler 10a. Alternatively, the smart connector 36 can be located on the machine or on the complimentary coupler 10b. In this embodiment, the device connector 44 would connect to the complimentary coupler 10b and data signals and power would pass, if needed by the work tool 12, through the complementary electrical connectors 23a and electrical connectors 23b to the work tool.

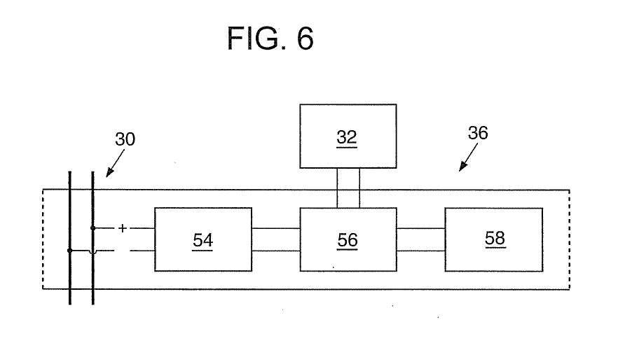

FIG. 6 is a block diagram of a smart chip 42 (FIG. 5) connected to the conductor according to one embodiment of the present disclosure. The smart chip 42 may comprise an optional contact device 54, a receiver/transmitter 56 and a processor 58, such as a computing processor. The smart chip 42 additionally contains other components as necessary such as device 32.

The processor 58 may be programmed from a system controller 34 through the receiver/transmitter 56, may be pre-programmed to recognize connection to a new device 32, may be programmed from the device 32 itself, or may be programmed utilizing any other device 32 having programming capability. A data message may then be sent to a display notifying the operator of a changed condition based on the programming. The changed condition may be approved or denied based on an operator input or a predetermined system protocol. The smart connector 36 may then be enabled to communicate information through the conductor 30.

The smart connector 36 may transmit commands, inquiries, or other data to the device 32, and also receive data from the device 32. Received data is processed and the smart connector 36 can take appropriate action based on the data. The smart connector 36 may then communicate by way of the conductor 30 to other smart connectors 36, devices 32, or the system controller 34. When a communication is sent over the conductor 30, the communication may be available for all smart connectors 36 to review. However, only the smart connector 36 to which the communication is addressed will normally utilize the information. The smart connector 36 or the smart chip 42 may be available as off the shelf products. Thus, the smart connector 36, by use of standard components, may be a generic, interchangeable product.

The smart connector 36 may have built-in current limiting capabilities. The processor 58 may be programmed such that it may detect the current flowing to the device 32 and determine if the current is within tolerance. If the current is not within tolerance, the processor 58 may then stop or limit current flow to the device 32. The processor 58 may also send an out of tolerance message to an operator. Alternative means for limiting current flow may be used, such as resistors, capacitors, transistors, fuses, breakers, shunt devices, and the like.

The processor 58 may be programmed such that it may send communications over the conductor 30 on a predetermined frequency. This predetermined frequency may be operator selected based on a desired frequency, may be selected based on available bandwidth, or may be selected based on some other criteria, such as system condition, location, available communication means, regulated restrictions, and the like. Alternatively, the communication may be sent in multiple redundant packets using a plurality of frequencies or a plurality of communication protocols.

While the smart connector 36 is shown to contain certain components, it will be appreciated that the smart connectors 36 may be configured consistently across the conductor 30 or may be configured in different ways for the different types of devices 32 being connected. In an example situation, the smart connector 36 may be configured to connect to devices 32 that do not require a data stream from the conductor 30. The smart connector 36, or tap, may be configured with only battery positive and battery negative wires to convey only power. In situations where devices 32 having sensor outputs are being connected, the smart connector 36 may contain a processor 58 and hardware to receive power and interpret data messages representative of the sensor output onto the conductor 30. Examples of devices 32 having sensor outputs include temperature sensors, brake pedal sensors, throttle pedal sensors, work tool pressure sensors and the like.

The smart connector 36 may also be configured to connect devices 32 that have a need for driven DC current, such as lamps, solenoids, and the like. The smart connector 36 in this instance may include a processor 58, hardware to receive power and interpret messages from the conductor 30, and driver output hardware (not shown) to supply a requisite amount of power to driven devices 32.

Furthermore, the smart connector 36 may be configured to connect devices 32 that have a communications output, such as a gauge cluster, keypad, and the like. This smart connector 36 configuration may include a processor 58 and hardware to interpret data between communication protocols of connected devices 32 and the communication protocol of the system. This setup can allow the devices 32 to effectively communicate and interact with the system.

In an embodiment, the work tool 12 identifies itself to at least one other device 32 connected to the power and data delivery system 26 by transmitting messages to the other device 32. Any appropriate method can be used for the work tool to identify itself. For example, if the work tool 12 is associated with a work tool coupler 10a having a built in smart connector 36, the smart connector 36 can store in memory the identification of the work tool. When the work tool coupler 10a and the complimentary coupler 10b mate, the smart connector can broadcast the work tool identification data over the two wire power and data delivery system network. If the smart connector 36 is located in the complimentary coupler 10b or on the machine itself, the work tool can have a memory that stores information regarding the type of work tool. Additionally, each work tool may have a unique resistor value. By measuring the resistor value, the machine can determine the type of work tool that is attached. Other methods may be used to determine the type of work tool attached, such as using radio frequency identification or bar codes and scanners.

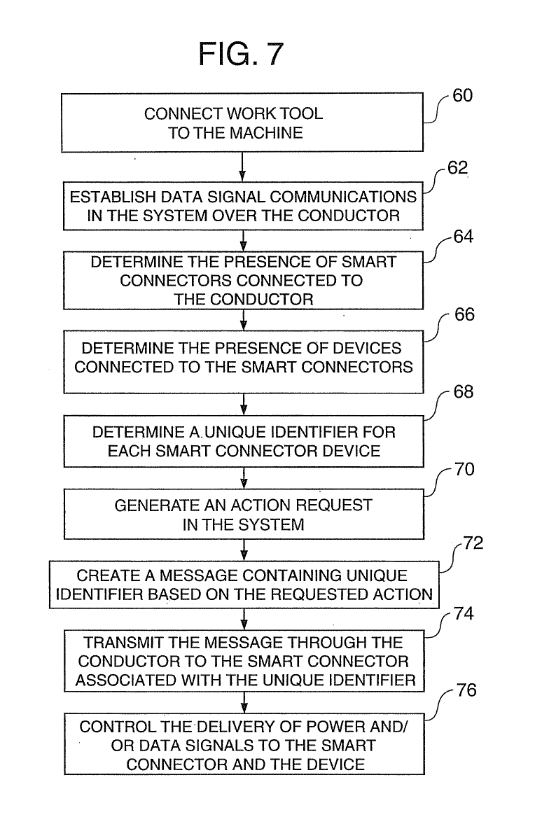

FIG. 7 is a flow diagram depicting steps of operation of a work tool coupler 10a including a power and data delivery system according to one embodiment of the present disclosure. Once the work tool is attached to the machine (first step 60) and data signal communications are established over the conductor 30 (second step 62), the presence of smart connectors 36 and devices 32 connected to the smart connectors 36 may be determined (third step 64 and fourth step 66). After establishing communications, the system determines unique identifiers for each smart connector 36 and device 32, including the work tool (fifth step 68), thus associating the smart connector 36 with the work tool with the machine. The unique identifier designates each device 32 connected to the system. Thereby, the enumeration of devices 32 by the system takes place. The unique identifiers can be determined using the system controller 34, or other controller, such as an electronic control module located in the machine. After determining the unique identifier, the identifier is associated with the smart connector 36 and device 32 and each device 32 is enumerated in the system., thereby forming a communication node in the system.

As a requested action is generated within the system (sixth step 70), a message may be created containing the unique identifier based upon the requested action (seventh step 72). For example, if the message is intended for the work tool, then the unique identifier of the work tool, created during fifth step 68, is used. The message may be created based on a result of the requested action. After generating the message, the message may then be transmitted through the conductor 30 to the smart connector 36 associated with the unique identifier from the requested action (eighth step 74). In response to receiving the message, the delivery of power and data signals may be controlled to the smart connector 36 and device 32 (ninth step 76). For example, the system controller 34 may be responsible for controlling the delivery of power and data signals throughout the system. When a new work tool is attached to the machine, the system can either continue using the same unique identify that was used for the previously attached work tool, if the new work tool is replacing a work tool, or the system can assign a new unique identifier to the new work tool.

### INDUSTRIAL APPLICABILITY

The industrial applicability of the work tool coupler including the power and data delivery system described herein will be readily appreciated from the foregoing discussion. The present disclosure is applicable to many types of machines that utilize removable work tools and require power and data to be routed throughout the machine. For example, wheel loaders, excavators, track loaders and other stationary and mobile machines can benefit from the present disclosure.

The described work tool coupler allows an operator to quickly and efficiently attach a work tool to a machine without having to exit the machine and perform labor-intensive tasks. Further, machine productivity can be improved because work tools can be attached and detached more quickly, allowing the machine to spend more time performing its assigned task. Utilizing the described data and power delivery system minimizes the electrical connections needed for the work tool. By minimizing the electrical connections, the work tool coupler has fewer parts and electrical plugs that could become blocked by dirt and other foreign matter.

The described work tool coupler and power and data delivery system provides an improved system and method for attaching work tools to a machine and providing both power and data to the work tool. The described system reduces the need for cumbersome wiring harnesses for bundling data lines and power lines together so that the lines can be routed throughout a machine and to attached work tools.

It will be appreciated that the foregoing description provides examples of the disclosed work tool coupler and power and data distribution system. However, it is contemplated that other implementations of the disclosure may differ in detail from the foregoing examples. All examples are intended to reference the particular example being discussed at that point and are not intended to imply any limitation as to the scope of the disclosed innovations more generally. All language of distinction and disparagement with respect to certain features is intended to indicate a lack of preference for those features, but not to exclude such from the scope of the disclosed principles entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosed principles unless otherwise indicated herein or otherwise clearly contradicted by context.

I claim:

1. A coupler for attaching a tool to a machine capable of enumerating attachments thereto which are located at respective ones of a plurality of communication nodes, the coupler comprising:
a tool coupler housing sized to matingly engage a complimentary coupler housing, and
an electrical connector, disposed within the tool coupler housing, the electrical connector configured to create an electrical connection between the tool and the machine at a first communication node of the plurality of communication nodes by providing a circuit pathway for a conductor adapted to deliver both power and data to a plurality of devices connected to the machine,
the conductor being adapted to transmit a message containing tool identification information from the first communication node when the tool coupler housing is connected to the complimentary coupler housing.

2. The coupler of claim 1, further comprising a hydraulic connector disposed within the tool coupler housing, the hydraulic connector configured to create a hydraulic connection between the tool and the machine.

3. The coupler of claim 1, wherein the communication node comprises an electrical smart connector at the complimentary coupler housing for enumeration by the machine.

4. The coupler of claim 3 wherein the electrical smart connector contains a computing processor for receiving a data message from the machine.

5. The coupler of claim 4 wherein the electrical smart connector is adapted to transmit identification data to the machine each time a new tool is attached to the machine.

6. The coupler of claim 1 wherein at least one enumerated communication node has an identifier associated with it that is unique over the machine.

7. The coupler of claim 1 further comprising an electrical smart connector creating the communication node at the tool coupler housing for enumeration by the machine.

8. The coupler of claim 1 wherein at least one communication node is a system controller.

9. A power and data delivery system for a machine having a coupler for attaching tools to the machine comprising:
a tool coupler housing sized to matingly engage a complimentary coupler housing;
a conductor for delivering power on the machine;
an electrical connector, disposed within the tool coupler housing, the electrical connector configured to create an electrical connection between a tool and the machine;
the tool coupler housing forming a communication node and connected to the conductor, the communication node transmitting and receiving a data message on the conductor;
the communication node adapted to transmit signals over the electrical connector in response to data received from the conductor.

10. The system of claim 9, further comprising a hydraulic connector disposed within the tool coupler housing, the hydraulic connector configured to create a hydraulic connection between the tool and the machine

11. The system of claim 9, further comprising an electrical smart connector creating the communication node at the tool coupler housing when the tool coupler housing matingly engages the complimentary coupler housing for enumeration by the machine.

12. The system of claim 11 wherein the electrical smart connector contains a computing processor for receiving data messages from the machine.

13. The system of claim 9 further comprising a plurality of communication nodes connected to the conductor.

14. The system of claim 13 wherein at least one of the plurality of communication nodes is a system controller to control a flow of messages between the plurality of communication nodes.

15. The system of claim 14 wherein a unique identifier designates each of the plurality of communication nodes connected to the conductor.

16. A method of associating a tool with a machine using a power and data delivery system, comprising:
engaging a tool coupler housing and a complimentary coupler housing such that the tool coupler housing and the complimentary coupler housing and all associated electrical connections are mated at a node;
establishing data signal communications with the node over a conductor configured to deliver power on the machine;
determining the presence of at least one additional node connected to the conductor;
determining a unique identifier for the node; and
controlling the delivery of power and data to the tool.

17. The method of claim 16, further comprising:
generating a requested action in the system;
creating a message based on the requested action, the message containing the unique identifier;
transmitting the message through the conductor; and
receiving the message at the node.

18. The method of claim 17, further comprising:
creating a second message based on a result of the requested action, the second message containing a second unique identifier for a second node;
transmitting the second message through the conductor; and
receiving the second message at the second node.

19. The method of claim 17, further comprising:
transmitting at least one of the power and data signals from the conductor to a device through the node according to the requested action.

20. The method of claim 16, further comprising:
associating the unique identifier with a device connected to the node.
